(19) United States
(12) Patent Application Publication
(10) Pub. No.: US 2015/0066726 A1
(43) Pub. Date: Mar. 5, 2015

(54) Method and Apparatus for Facilitating Entering Deals and Assets Using Natural Language Processing

(71) Applicants: Adam Gregory Todd Strickland, Dallas, TX (US); Sameer Soleja, Houston, TX (US); J. Frederick Lindner, Houston, TX (US)

(72) Inventors: Adam Gregory Todd Strickland, Dallas, TX (US); Sameer Soleja, Houston, TX (US); J. Frederick Lindner, Houston, TX (US)

(21) Appl. No.: 14/013,013

(22) Filed: Aug. 28, 2013

(51) Int. Cl. G06Q 40/04; G06F 17/28

(52) U.S. Cl. CPC G06Q 40/04; G06F 17/28
USPC 705/37

(57) ABSTRACT

The system offers light, fast, cost effective natural language processing software for energy trades. The system software provides users with real-time answers to questions and reconciliation on position, profitability, and risk, for deals concerning any energy market, including electricity, natural gas, crude, and liquids.

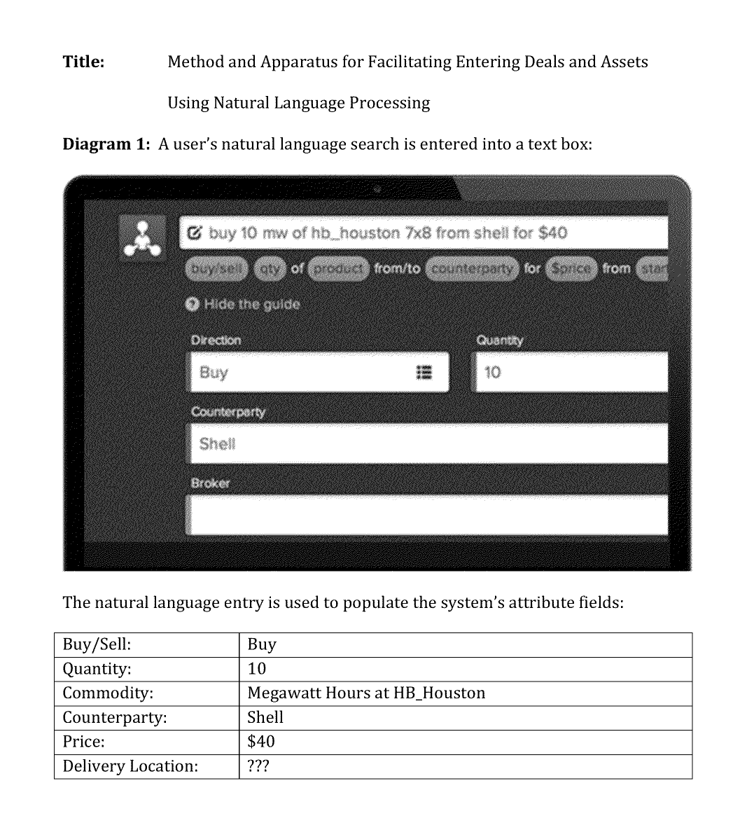

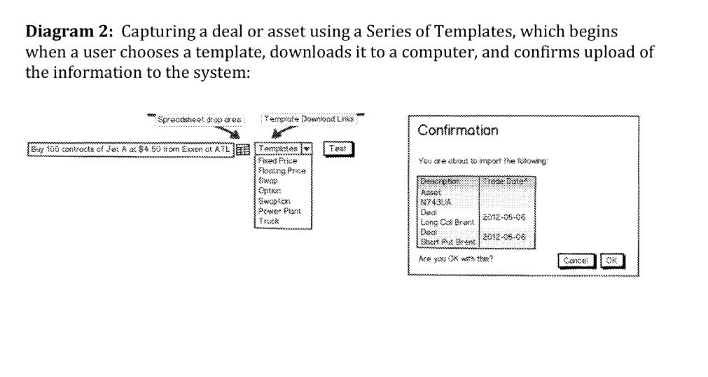

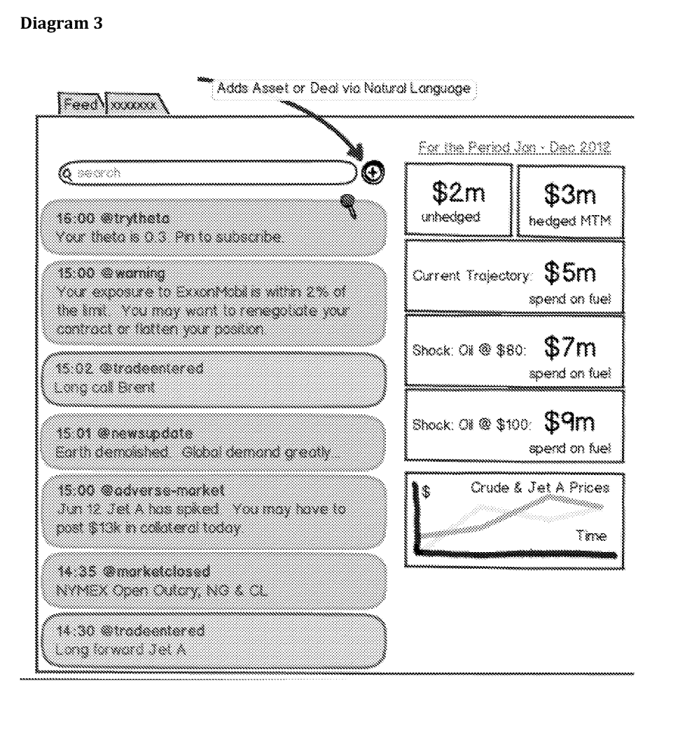

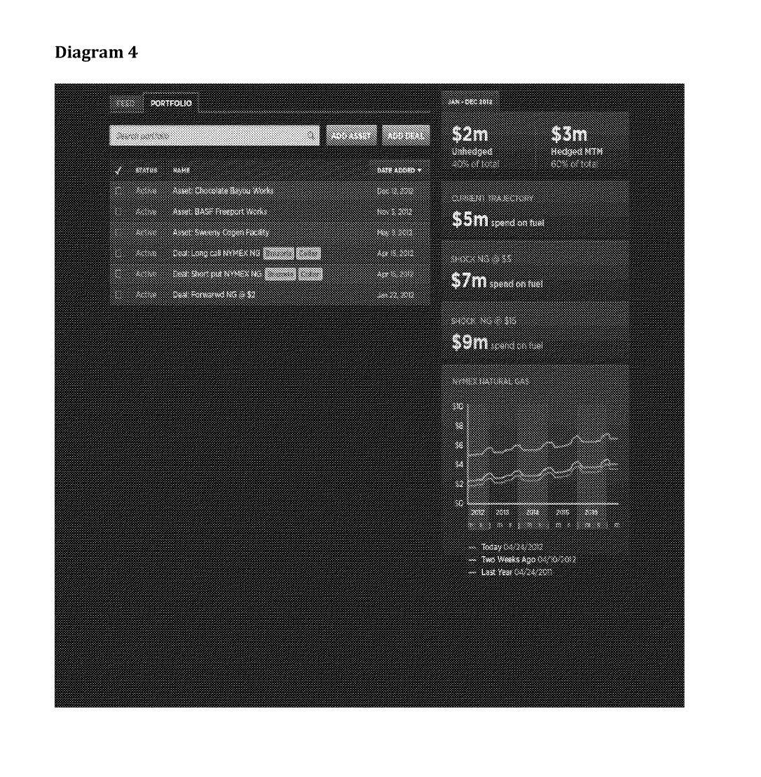

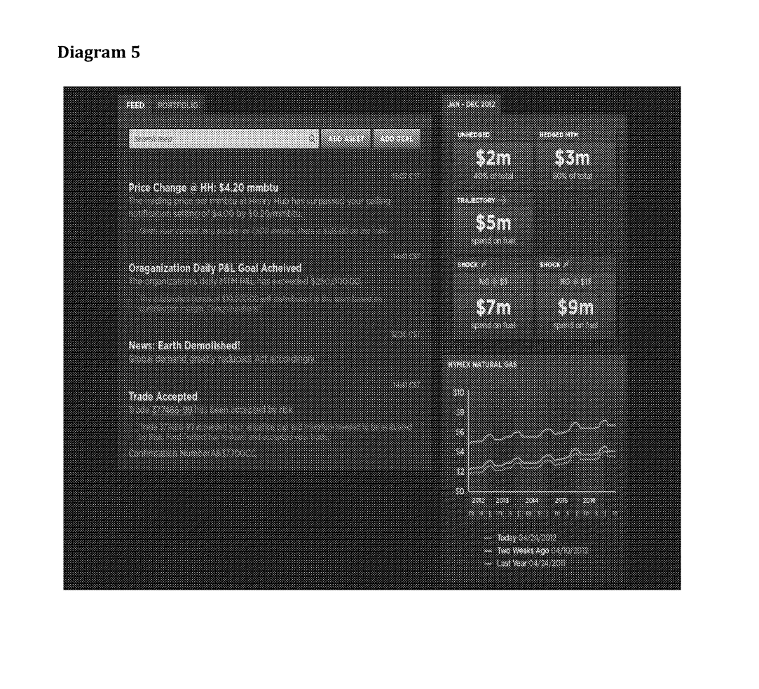

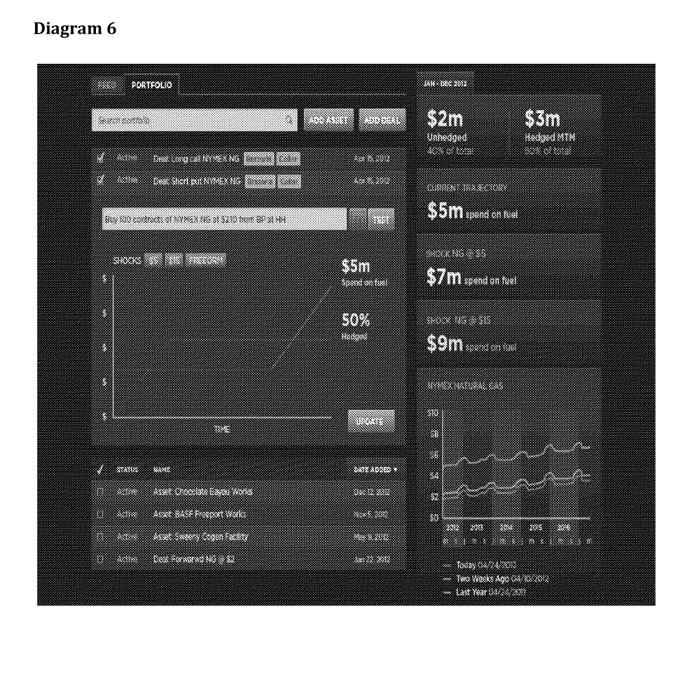

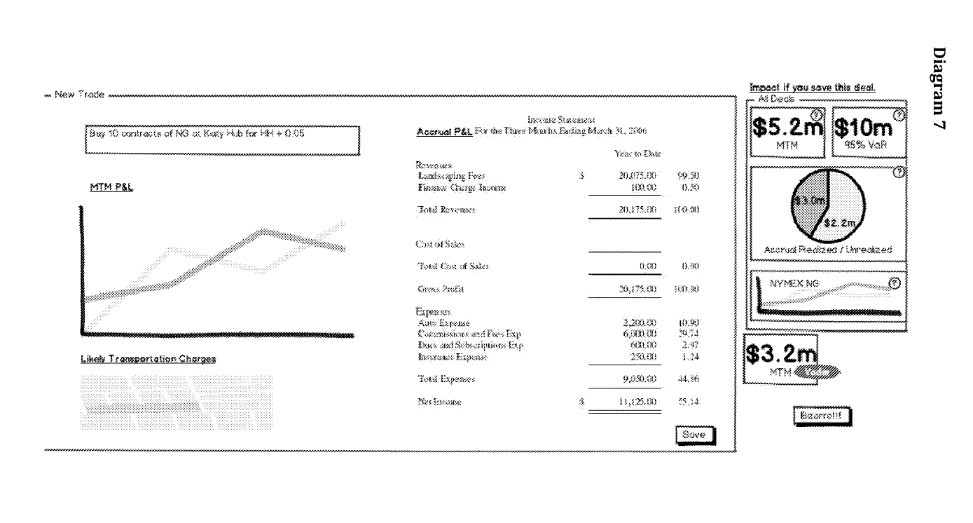

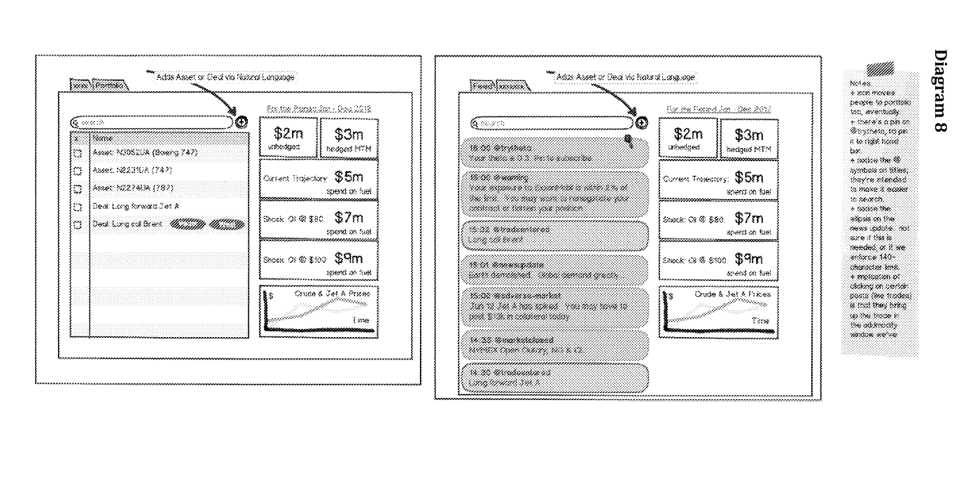

### RELATED APPLICATIONS (37 CFR 1.77(b)(2))

Application Ser. No. 13/899,217 was originally filed on May 21, 2013. This is a substitute specification, as requested by Notice of Incomplete Nonprovisional Application mailed on Jun. 28, 2013.

### FEDERAL SPONSORSHIP (37 CFR 1.77(b) (3))

Not applicable.

### JOINT RESEARCH AGREEMENT (37 CFR 1.77(b) (4))

Not applicable.

### SEQUENCE LISTING (37 CFR 1.77(b)(5))

Not applicable.

### BACKGROUND OF THE INVENTION (37 CFR 1.77(b)(6))

1. Field of the Invention

The invention generally relates to the method and apparatus for facilitating entering deals and assets using natural language processing.

2. Background

The invention was prompted by the way users have traditionally conducted energy trades, using paper spreadsheets and software programs that require long and drawn out data entry process, which have a tendency of being different and/or inconsistent between deal types, asset types, and commodities, and which do not offer real-time information about the relevant energy market data. This invention addresses these inefficiencies through natural language processing of deals and assets in a real-time environment.

### BRIEF SUMMARY OF THE INVENTION (37 CFR 1.77(b)(7))

The system offers light, fast, cost-effective natural language processing software for energy trades. The system software provides users with real-time answers to questions and reconciliation on position, profitability, and risk, for deals concerning any energy market, including electricity, natural gas, crude, and liquids.

### DESCRIPTION OF THE SEVERAL VIEWS OF THE DRAWINGS (37 CFR 1.77(b)(8))

The figure illustrates an example of the natural language processing system, its data entry, and the resulting analysis of the information submitted by a user. The figure is further described and referenced in the claims.

### DETAILED DESCRIPTION OF THE INVENTION (37 CFR 1.77(B)(9))

This invention addresses the inefficiencies of traditional energy trades, which use paper spreadsheets or multiple, antiquated software programs, through natural language processing of deals and assets in a real time environment. The system embodies several compatible methods to use and analyze user data to achieve these aims.

First, the method for capturing a deal or asset using natural language in a single text entry field. Diagram 1 illustrates a user's natural language entry of a deal and the system's conversion of that data into fields.

Second, the method for capturing a deal or asset using a series of templates. Diagram 2 illustrates an example of this method, which allows a user to choose from several templates, download the chosen template to a user computer, and then upload the information to the system for complete analysis.

Third, the method of processing, displaying, and marketing portfolio information asynchronously. Diagram 3 illustrates a user's data entry. Diagrams 4-8 offer examples of sub-components of Diagram 3.

1: Method for capturing a deal or asset (“trade capture”) using Natural Language.
1. The system requires that deals (trades) and assets be entered into the system. These objects take a variety of forms and have a variety of different fields. In order to minimize the amount of choices users must make to enter a deal or asset into the system, the system will use natural language processing to process object entry.
2. A user will start to type aspects of a deal or asset into a text entry box. See, e.g., Diagram 1. As soon as letters or words are typed, the system will process the character string and attempt to identify the type of object being entered and the attributes within it. As it does so, the system will display a view of the type of object being entered, the attributes that it has captured, and the attributes that are still missing. Once all attributes are determined, the system will facilitate entering the trade or asset into a structured data repository.

2: Method for capturing a deal or asset (“trade capture”) using a Series of Templates.
1. The system has a primary means of entering deal (trade) or asset information: a form. However, it can be cumbersome for a user to use the form in all cases. When entering multiple deals or assets, or when entering in complex deals that are already modeled in speadsheets, the system allows the user the ease of uploading a spreadsheet.
2. The user's screen displays two elements: (a) a “file drop” area, and (b) a list of spreadsheet template links that can be downloaded. See, e.g., Diagram 2. Upon clicking a template link, the appropriate spreadsheet template is downloaded to a user's computer. These templates represent multiple asset and deal types (i.e. Power Plant, Truck, Swap, Swaption, Fixed Price, Floating Price, etc.).
3. The user fills in the spreadsheet template with the appropriate information. The user then saves the file and drops it on the “file drop” area of the computer screen.
4. The system processes the file based on specifying characteristics (i.e., a hidden field, or simply by the number of columns and the data contained within those columns) and presents a confirmation to the user of what information is about to be imported. If the user accepts the confirmation, the data is imported into the system as the correct type of deal or asset.

3: Method for processing, displaying, and marketing portfolio information asynchronously (feed/API).
1. The system, by virtue of its function, has many bits of relevant data about a user's portfolio of trades, contracts, energy-consuming assets, market prices, and more. Finding interesting information about recent and impending events is time consuming, comes from disparate sources, and often represent incongruous data sets (i.e., differing time spans, methods of valuation, etc.), and therefore would be difficult for a user to timely collect and efficiently analyze. By analyzing a user's data, the system can present information that is interesting and relevant for a given user. See, e.g., Diagram 3. This can be done automatically (“push”) or as requested by the user (“preset”).
2. The system includes a notification framework for sub-components to listen for events. Such events could include:
Trade created or revised
Market Data created or revised
Contracts or credit information created or revised
Shock scenario changed
News occurred
Predictable event occurred (i.e., market closing for the day)
3. Sub-components are designed to listen for one or more of these events and then produce output based on these events. For example, a sub-component could listen for market movements that would impact collateral needs and determine whether a user might need to post collateral today (or soon). A sub-component could listen for trade entry and market movements that would impact a user's credit limit with a trading counterparty and determine whether the user is outside (or close to) a credit limit. Or a sub-component could listen for the entry of options trades and recalculate the “greek”, i.e., a commonly-known calculation regarding options risks, like “theta”. See, e.g., Diagrams 4-8.
4. Sub-components would do their processing asynchronously; meaning the system could continue to operate while any or all sub-components are performing their analysis.
5. Each sub-component would have the ability to be visualized (a) as a text message or Twitter-style “notification” in a timeline and/or (b) as a “widget” to be pinned to a user's screen.
6. A sub-component could be provided to a user for free or on a trial basis with an option for a subscription. A sub-component could be written by any vendor and integrated into the system, with royalties returned to the vendor, if desired.
SEQUENCE LISTING (37 CFR 1.77(B)(12))
Not applicable.
